(19) United States
(12) Patent Application Publication
(10) Pub. No.: US 2026/0194949 A1
(43) Pub. Date: Jul. 9, 2026

(54) UNINTERRUPTIBLE POWER SUPPLY SYSTEM

(71) Applicant: TMEIC Corporation, Tokyo (JP)

(72) Inventor: Jun MATSUMOTO, Chuo-ku (JP)

(73) Assignee: TMEIC Corporation, Tokyo (JP)

(21) Appl. No.: 19/131,567

(22) PCT Filed: Oct. 25, 2023
(86) PCT No.: PCT/JP2023/038476

§ 371 Date: May 21, 2025

(51) Int. Cl. G06F 1/26

(52) U.S. Cl. CPC G06F 1/266

(57) ABSTRACT

An UPS system includes: N UPSs connected in parallel between an AC power supply and a load; a current detector that detects a load current; and a controller. Each of the UPSs includes: a converter; and an inverter. Each of the UPSs switches between a first power feeding mode and a second power feeding mode, the first power feeding mode being a mode of supplying DC power generated by the converter to the inverter and storing the DC power in a power storage device, the second power feeding mode being a mode of supplying the DC power of the power storage device to the inverter. The controller sets the M UPSs to the second power feeding mode and sets the N−M UPSs to the first power feeding mode, when the AC power supply is sound and when the load current is smaller than a threshold current.

### TECHNICAL FIELD

The present disclosure relates to an uninterruptible power supply system.

### BACKGROUND ART

For example, Japanese Patent Laying-Open No. 2020-005410 (PTL 1) discloses an uninterruptible power supply system including a plurality of uninterruptible power supply devices connected in parallel between an alternating current (AC) power supply and a load. Each of the uninterruptible power supply devices is configured to include a converter that converts AC power from the AC power supply into direct current (DC) power, and an inverter that converts DC power from the converter or a power storage device into AC power and supplies the AC power to the load.

In this uninterruptible power supply system, of the plurality of uninterruptible power supply devices, the number of uninterruptible power supply devices required to supply a load current is selected. The selected uninterruptible power supply devices are put into an operating state of supplying power to the load, and the unselected uninterruptible power supply devices are put into a standby state of not supplying power to the load. When the uninterruptible power supply device is put into the standby state, the converter and the inverter are stopped. When the uninterruptible power supply device is put into the operating state, the converter and the inverter are operated.

### CITATION LIST

### Patent Literature

PTL 1: Japanese Patent Laying-Open No. 2020-005410

### SUMMARY OF INVENTION

### Technical Problem

In the uninterruptible power supply device put into the operating state, each of a plurality of semiconductor switching elements that constitute the converter is PWM (pulse width modulation)-controlled by a control circuit and is turned on/off at prescribed timing in synchronization with an AC voltage from the AC power supply.

At this time, a harmonic current is generated in the converter and flows out to the AC power supply. The harmonic current flowing out to the AC power supply may also affect a higher-level power supply system. Nowadays, an output capacity of an uninterruptible power supply device is increasing, and with this increase in output capacity, a harmonic current flowing out to an AC power supply also tends to increase.

Generally, as long as a plurality of semiconductor switching elements are PWM-controlled, a harmonic current generated in a converter is almost constant regardless of the magnitude of a load. Therefore, in an uninterruptible power supply device having a large output capacity, a harmonic current having the magnitude corresponding to the output capacity flows out to an AC power supply even when the uninterruptible power supply device is operating at light load.

In the above-described uninterruptible power supply system, a part of the plurality of uninterruptible power supply devices are put into the standby state and the operation thereof is stopped in accordance with the load current. Therefore, an outflow of the harmonic currents in the converters of the uninterruptible power supply devices in the standby state is suppressed. However, a sum of the harmonic currents generated in the converters of the uninterruptible power supply devices in the operating state flows out to the AC power supply. In addition, since the uninterruptible power supply devices in the standby state are activated after the load increases, a response speed to load variations becomes slower.

The present disclosure has been made to solve the above-described problems, and an object of the present disclosure is to reduce a harmonic current flowing out to a commercial AC power supply while ensuring a quick response to load variations and a power failure compensation function, in an uninterruptible power supply system including a plurality of uninterruptible power supply devices connected in parallel between an AC power supply and a load.

### Solution to Problem

An uninterruptible power supply system according to the present disclosure includes: N uninterruptible power supply devices connected in parallel between an AC power supply and a load; a current detector that detects a load current; and a controller. N is an integer equal to or greater than 2, and M is an integer equal to or greater than 1 and less than N. Each of the uninterruptible power supply devices includes: a DC line that transmits DC power; a converter; and an inverter. The converter converts AC power supplied from the AC power supply into DC power and supplies the DC power to the DC line. The inverter converts DC power received from the DC line into AC power and supplies the AC power to the load. Each of the uninterruptible power supply devices is configured to switch between a first power feeding mode and a second power feeding mode, the first power feeding mode being a mode of supplying the DC power generated by the converter to the inverter and storing the DC power in a power storage device, the second power feeding mode being a mode of supplying the DC power of the power storage device to the inverter. The controller i) sets the N uninterruptible power supply devices to the first power feeding mode, when the AC power supply is sound and when the load current detected by the current detector is greater than a predetermined threshold current. The controller ii) sets the N uninterruptible power supply devices to the second power feeding mode, when the AC power supply has a power failure. The controller iii) sets the M uninterruptible power supply devices of the N uninterruptible power supply devices to the second power feeding mode and sets the N−M uninterruptible power supply devices to the first power feeding mode, when the AC power supply is sound and when the load current detected by the current detector is smaller than the threshold current.

### Advantageous Effects of Invention

According to the present disclosure, it is possible to reduce a harmonic current flowing out to a commercial AC power supply while ensuring a quick response to load variations and a power failure compensation function, in an uninterruptible power supply system including a plurality of uninterruptible power supply devices connected in parallel between an AC power supply and a load.

### BRIEF DESCRIPTION OF DRAWINGS

FIG. 1 is a circuit block diagram showing a configuration of an uninterruptible power supply system according to a first embodiment.

FIG. 2 is a circuit block diagram showing a configuration of a UPS.

FIG. 3 is a block diagram showing a configuration of a portion of a control circuit related to the control of a converter.

FIG. 4 is a circuit block diagram for describing an operation of the uninterruptible power supply system when a commercial AC power supply is sound.

FIG. 5 is a circuit block diagram for describing an operation of the uninterruptible power supply system when M=1.

FIG. 6 is a diagram for describing the SOC of a battery.

FIG. 7 is a diagram for describing a rotation process in the uninterruptible power supply system.

FIG. 8 is a block diagram showing configurations of a controller and a control circuit of the UPS.

FIG. 9 is a flowchart for describing the control of each UPS by the controller.

FIG. 10 is a circuit block diagram showing a configuration of an uninterruptible power supply system according to a second embodiment.

FIG. 11 is a circuit block diagram for describing an operation of the uninterruptible power supply system when M=1.

FIG. 12 is a circuit block diagram for describing an operation of the uninterruptible power supply system when M=2.

### DESCRIPTION OF EMBODIMENTS

Hereinafter, embodiments of the present disclosure will be described in detail with reference to the drawings. In the following description, the same or corresponding portions in the drawings are denoted by the same reference characters and description thereof will not be repeated in principle.

### First Embodiment

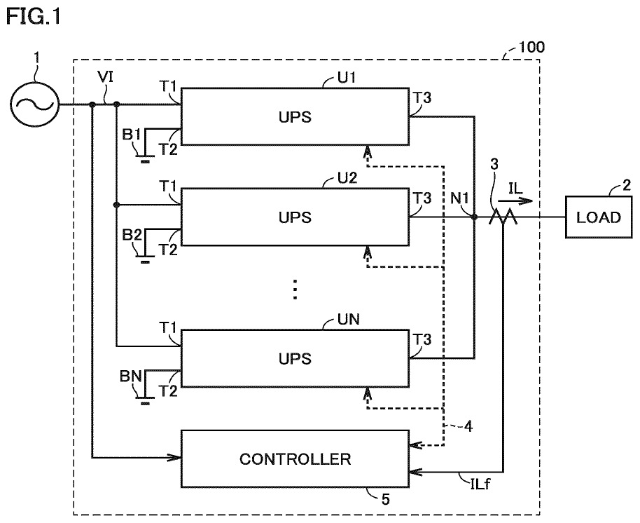

FIG. 1 is a circuit block diagram showing a configuration of an uninterruptible power supply system according to a first embodiment. An uninterruptible power supply system 100 according to the first embodiment receives three-phase AC power of a commercial frequency from a commercial AC power supply 1, and supplies the three-phase AC power of the commercial frequency to a load 2. However, for the sake of simplification of the figure and the description, FIG. 1 shows only a portion related to one phase.

As shown in FIG. 1, uninterruptible power supply system 100 includes N uninterruptible power supply devices (hereinafter, also referred to as “UPSs”) U1 to UN, N batteries B1 to BN, a current detector 3, a communication line 4, and a controller 5. N is an integer equal to or greater than 2. Hereinafter, UPS U1 to UPS UN may be collectively referred to as “UPS U”. Batteries B1 to BN may be collectively referred to as “battery B”.

UPS U includes an input terminal T1, a battery terminal T2 and an output terminal T3. Input terminal T1 receives the AC power of the commercial frequency supplied from commercial AC power supply 1. An instantaneous value of an AC voltage V1 of input terminal T1 (i.e., an AC voltage supplied from commercial AC power supply 1) is detected by controller 5.

Battery terminals T2 of UPSs U1 to UN are connected to batteries B1 to BN, respectively. Battery B constitutes “storage battery” that stores DC power. Battery B is a secondary battery such as a lead-acid battery or a lithium battery. Instead of battery B, an electric double-layer capacitor may be connected. Output terminals T3 of UPSs U1 to UN are all connected to a node N1, and node N1 is connected to load 2. That is, UPSs U1 to UN are connected in parallel between commercial AC power supply 1 and load 2.

When the AC power is normally supplied from commercial AC power supply 1 (when commercial AC power supply 1 is sound), UPSs U1 to UN temporarily convert the AC power from commercial AC power supply 1 into DC power and supplies the DC power to batteries B1 to BN, and converts the DC power into AC power of a commercial frequency and supplies the AC power of the commercial frequency to load 2. Load 2 is driven by the AC power supplied from UPSs U1 to UN.

When the AC power is no longer normally supplied from commercial AC power supply 1 (when a power failure of commercial AC power supply 1 occurs), UPSs U1 to UN converts the DC power of batteries B1 to BN into AC power and supplies the AC power to load 2. Therefore, the operation of load 2 can be continued during a time period for which the DC power is stored in batteries B1 to BN.

Current detector 3 detects an instantaneous value of an AC current (hereinafter, also referred to as “load current IL”) flowing between node N1 and load 2, and outputs a signal ILf indicating the detected value to controller 5. UPSs U1 to UN and controller 5 are connected to each other by communication line 4. Each UPS U receives and transmits various types of information and signals to and from controller 5 through communication line 4.

Controller 5 controls the operation of UPSs U1 to UN based on the instantaneous value of AC voltage V1 of input terminal T1, output signal ILf of current detector 3 and the like. In an aspect, controller 5 is implemented by a microcomputer that executes a prescribed program. In another aspect, at least a part of controller 5 can be configured using circuitry such as a field programmable gate array (FPGA) or an application specific integrated circuit (ASIC). Alternatively, at least a part of controller 5 can also be configured by an analog circuit.

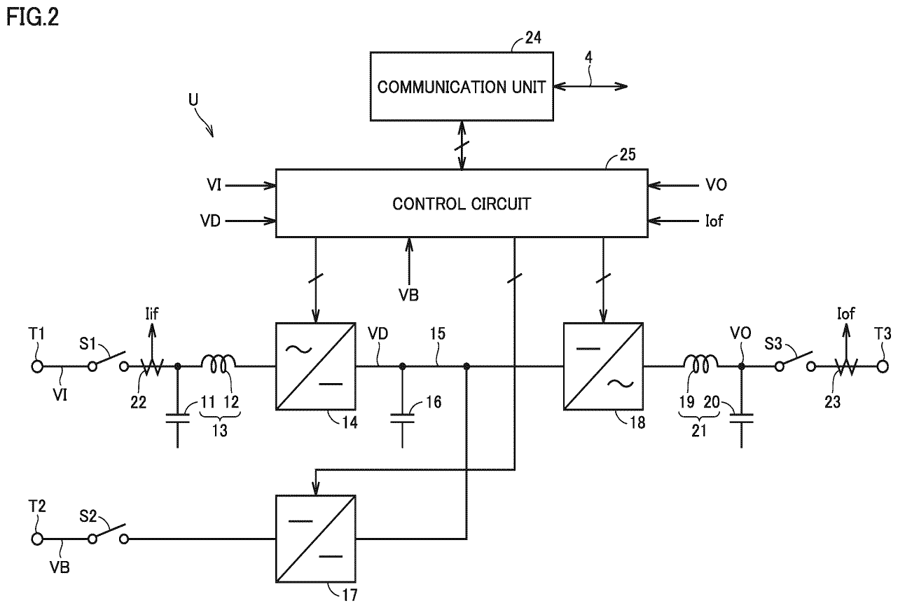

FIG. 2 is a circuit block diagram showing a configuration of UPS U. UPS U receives the three-phase AC power and outputs the three-phase AC power. However, for the sake of simplification of the figure and the description, FIG. 2 shows only a portion related to one phase.

As shown in FIG. 2, UPS U includes input terminal T1, battery terminal T2, output terminal T3, switches S1 to S3, capacitors 11, 16 and 20, reactors 12 and 19, a converter 14, a DC line 15, an inverter 18, a bidirectional chopper 17, current detectors 22 and 23, a communication unit 24, and a control circuit 25. Input terminal T1, battery terminal T2 and output terminal T3 are as shown in FIG. 1.

A first terminal of switch S1 is connected to input terminal T1, and a second terminal thereof is connected to an input node of converter 14 with reactor 12 interposed therebetween. Capacitor 11 is connected to the second terminal of switch S1. An output node of converter 14 is connected to an input node of inverter 18 through DC line 15 and is connected to a first input/output node of bidirectional chopper 17. Capacitor 16 is connected to DC line 15.

An output node of inverter 18 is connected to a first terminal of switch S3 with reactor 19 interposed therebetween. A second terminal of switch S3 is connected to output terminal T3. Capacitor 20 is connected to the first terminal of switch S3. A first terminal of switch S2 is connected to battery terminal T2, and a second terminal thereof is connected to a second input/output node of bidirectional chopper 17.

Capacitor 11 and reactor 12 constitute an AC filter 13. AC filter 13 is a low pass filter, which allows the AC power of the commercial frequency supplied from commercial AC power supply 1 to pass therethrough and prevents a signal of a switching frequency generated in converter 14 from flowing to the commercial AC power supply 1 side.

Capacitor 20 and reactor 19 constitute an AC filter 21. AC filter 21 is a low pass filter, which allows three-phase AC power of a commercial frequency generated by inverter 18 to flow to load 2 and prevents a signal of a switching frequency generated in inverter 18 from flowing to load 2.

Switch S1 is controlled by control circuit 25. Switch S1 is turned on when commercial AC power supply 1 is sound, and is turned off when commercial AC power supply 1 has a power failure. Switch S2 is controlled by control circuit 25. Switch S2 is turned on normally, and is turned off at the time of maintenance of battery B, for example. Switch S3 is controlled by control circuit 25. Switch S3 is turned on when corresponding UPS U is put into an operating state, and is turned off when corresponding UPS U is put into a stop state.

AC voltage V1 of input terminal T1, an AC voltage VO of output terminal T3, a DC voltage VB of battery terminal T2 (i.e., a terminal-to-terminal voltage of battery B), and a DC voltage VD of DC line 15 are provided to control circuit 25.

Current detector 22 detects an AC current Ii flowing between commercial AC power supply 1 and converter 14, and provides a signal Iif indicating the detected value to control circuit 25. Current detector 23 detects an AC current Io flowing through reactor 19 (i.e., an output current of inverter 18), and provides a signal Iof indicating the detected value to control circuit 25.

Communication unit 24 is provided between control circuit 25 and communication line 4, and receives and transmits various types of information and signals to and from controller 5.

UPS U has a commercial power feeding mode and a battery power feeding mode. The commercial power feeding mode is a power feeding mode of supplying the AC power supplied from commercial AC power supply 1 to load 2 through converter 14 and inverter 18. The battery power feeding mode is a power feeding mode of supplying the DC power of battery B to load 2 through bidirectional chopper 17 and inverter 18. The commercial power feeding mode corresponds to “first power feeding mode” and the battery power feeding mode corresponds to “second power feeding mode”.

As described below, UPS U is set to one of the commercial power feeding mode and the battery power feeding mode, based on a mode command signal MS supplied from controller 5. Specifically, when commercial AC power supply 1 is sound, UPS U is set to one of the commercial power feeding mode and the battery power feeding mode. When commercial AC power supply 1 has a power failure, UPS U is set to the battery power feeding mode.

Converter 14 is a well-known converter including a plurality of semiconductor switching elements and a plurality of diodes. Converter 14 is controlled by control circuit 25. In the commercial power feeding mode, converter 14 converts the AC power from commercial AC power supply 1 into DC power and provides the DC power to inverter 18 and bidirectional chopper 17 through DC line 15. Converter 14 outputs a DC current to DC line 15 such that DC voltage VD of DC line 15 matches a reference DC voltage VDR. In the battery power feeding mode, the operation of converter 14 is stopped. Capacitor 16 smooths and stabilizes DC voltage VD of DC line 15.

Bidirectional chopper 17 is a well-known bidirectional chopper including a plurality of semiconductor switching elements and a plurality of diodes. Bidirectional chopper 17 is controlled by control circuit 25. Bidirectional chopper 17 stores the DC power generated by converter 14 in battery B in the commercial power feeding mode, and supplies the DC power of battery B to inverter 18 in the battery power feeding mode. In the commercial power feeding mode, bidirectional chopper 17 supplies a DC current to battery B such that terminal-to-terminal voltage VB of battery B matches a reference DC voltage VBR. In the battery power feeding mode, bidirectional chopper 17 outputs a DC current to DC line 15 such that DC voltage VD of DC line 15 matches reference DC voltage VDR.

Inverter 18 is a well-known inverter including a plurality of semiconductor switching elements and a plurality of diodes. Inverter 18 is controlled by control circuit 25. In the commercial power feeding mode and the battery power feeding mode, inverter 18 supplies a shared current Is, which is I/N of load current IL, to load 2. In the commercial power feeding mode, inverter 18 converts the DC power generated by converter 14 into AC power of a commercial frequency and supplies the AC power of the commercial frequency to load 2. In the battery power feeding mode, inverter 18 converts the DC power supplied from battery B through bidirectional chopper 17 into AC power of a commercial frequency and supplies the AC power of the commercial frequency to load 2.

Control circuit 25 controls converter 14, inverter 18 and bidirectional chopper 17 based on the instantaneous values of AC voltages VI and VO, the instantaneous values of DC voltages VB and VD, the detected value of current detector 22, the information and signals supplied from controller 5 through communication line 4 and communication unit 24, and the like.

Specifically, in the commercial power feeding mode, control circuit 25 controls converter 14 based on the instantaneous value of AC voltage V1 of input terminal T1, the instantaneous value of DC voltage VD of DC line 15, output signal Iif of current detector 22, a current command value from controller 5, and the like. As a result, DC voltage VD of DC line 15 is maintained at reference DC voltage VDR.

In the commercial power feeding mode, control circuit 25 controls bidirectional chopper 17 based on the instantaneous value of AC voltage V1 of input terminal T1, the instantaneous value of DC voltage VD of DC line 15, the instantaneous value of DC voltage VB of battery terminal T2, the current command value from controller 5, and the like. As a result, terminal-to-terminal voltage VB of battery B is maintained at reference DC voltage VBR.

Control circuit 25 controls inverter 18 based on the instantaneous value of AC voltage V1 of input terminal T1, the instantaneous value of AC voltage VO of output terminal T3, output signal Iof of current detector 23, the current command value from controller 5, and the like. As a result, the output current of inverter 18 is maintained at shared current Is.

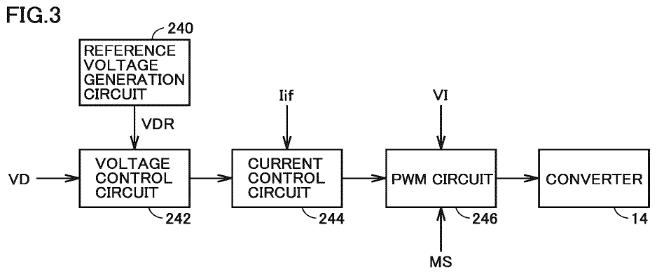

FIG. 3 is a block diagram showing a configuration of a portion of control circuit 25 related to the control of converter 14. As shown in FIG. 3, control circuit 25 includes a reference voltage generation circuit 240, a voltage control circuit 242, a current control circuit 244, and a pulse width modulation (PWM) circuit 246.

Reference voltage generation circuit 240 generates reference DC voltage VDR. Voltage control circuit 242 calculates a difference between reference DC voltage VDR and DC voltage VD, and generates a current command value for controlling a current flowing to the input side of converter 14 such that the difference becomes zero.

Current control circuit 244 calculates a difference between the current command value and AC current Ii (current flowing to the input side of converter 14) detected by current detector 22, and generates a voltage command value as a voltage to be applied to reactor 12 such that the difference becomes zero.

PWM circuit 246 generates a PWM signal for controlling the plurality of semiconductor switching elements included in converter 14, in accordance with mode command signal MS provided from controller 5. Specifically, when PWM circuit 246 receives mode command signal MS indicating the commercial power feeding mode, PWM circuit 246 generates a PWM signal in accordance with the voltage command value in synchronization with AC voltage V1 of input terminal T1, and controls converter 14 in accordance with the PWM signal. When PWM circuit 246 receives mode command signal MS indicating the bypass power feeding mode, PWM circuit 246 generates a PWM signal for turning off the plurality of semiconductor switching elements, and stops the operation of converter 14 in accordance with the PWM signal.

Next, the operation of uninterruptible power supply system 100 will be described.

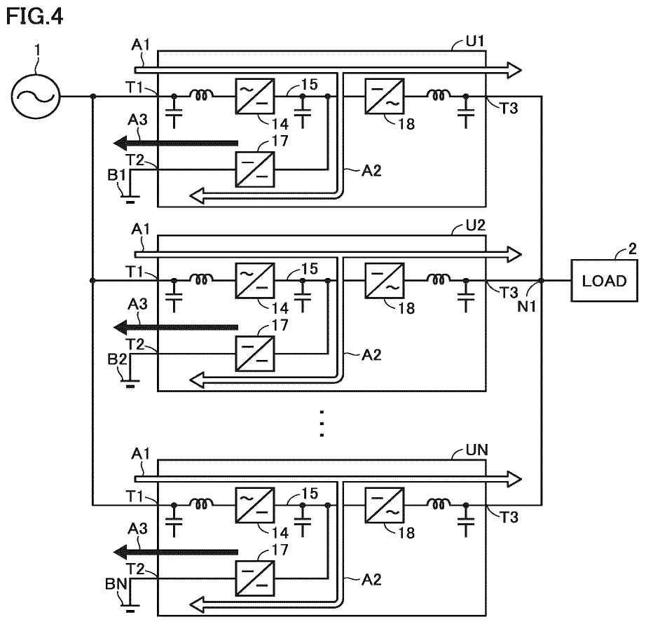

FIG. 4 is a circuit block diagram for describing an operation of uninterruptible power supply system 100 when commercial AC power supply 1 is sound. In FIG. 4, each of arrows A1 and A2 indicates a path through which electric power is supplied.

As shown in FIG. 4, each of UPSs U1 to UN is set to the commercial power feeding mode. In each UPS U, the AC power supplied from commercial AC power supply 1 is converted into DC power by converter 14 and the DC power is supplied to DC line 15, as shown by arrow A1. The DC power supplied to DC line 15 is converted into AC power by inverter 18 and the AC power is supplied to load 2. Inverter 18 outputs shared current Is, which is I/N of load current IL. The DC power supplied to DC line 15 is further stored in battery B through bidirectional chopper 17, as shown by arrow A2.

At this time, in each UPS U, a harmonic current is generated in converter 14. In FIG. 4, an arrow A3 indicates an outflow of the harmonic current to commercial AC power supply 1. Since UPSs U1 to UN are all set to the commercial power feeding mode, a sum of the harmonic currents generated in converters 14 of UPSs U1 to UN flows out to commercial AC power supply 1. The harmonic currents flowing out to commercial AC power supply 1 may also affect a not-shown higher-level power supply system.

As long as the plurality of semiconductor switching elements included in converter 14 are PWM-controlled, the harmonic current generated in converter 14 is almost constant regardless of the magnitude of load 2. Therefore, assuming that the magnitude of the harmonic current is represented by Ihd, the harmonic currents of Ihd×N always flow out to commercial AC power supply 1 in the situation in which UPSs U1 to UN are all set to the commercial power feeding mode.

Since Ihd tends to increase as an output capacity of UPS U increases, the problem of the harmonic current is more prominent in large-capacity uninterruptible power supply system 100.

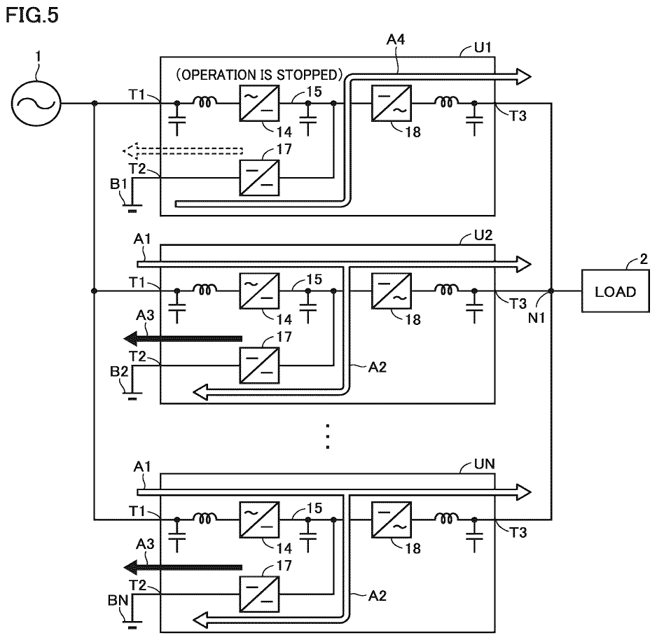

In order to deal with this harmonic current, in the present embodiment, M UPSs U of N UPSs U1 to UN are set to the battery power feeding mode and remaining N-M UPSs U are set to the commercial power feeding mode, as shown in FIG. 5. Mis an integer equal to or greater than 1 and less than N.

FIG. 5 shows an operation of uninterruptible power supply system 100 when M=1. In FIG. 5, UPS U1 is set to the battery power feeding mode and UPSs U2 to UN are set to the commercial power feeding mode.

In FIG. 5, an arrow A4 indicates a path through which electric power is supplied in UPS U1. In UPS U1, the operation of converter 14 is stopped and the DC power of battery B is supplied to DC line 15 through bidirectional chopper 17. The DC power supplied from bidirectional chopper 17 to DC line 15 is converted into AC power by inverter 18 and the AC power is supplied to load 2. Inverter 18 outputs shared current Is.

In UPS U1, the operation of converter 14 is stopped, and thus, no harmonic current is generated. That is, Ihd=0. On the other hand, UPSs U2 to UN are set to the commercial power feeding mode, and thus, the harmonic currents indicated by Ihd×(N−1) flow out to commercial AC power supply 1.

By setting M UPSs (e.g., UPS U1) of N UPSs U1 to UN to the battery power feeding mode as described above, the harmonic currents flowing from uninterruptible power supply system 100 to commercial AC power supply I can be reduced from Ihd×N to Ihd×(N−M), as compared with the case of setting all of N UPSs to the commercial power feeding mode (FIG. 4).

When viewed from the load 2 side, each of N inverters 18 outputs shared current Is similarly to the case in FIG. 4, and thus, load 2 can be supplied with load current IL. Therefore, load 2 is not affected by the stop of the operation of M converters 14.

Even when the operation of converters 14 and inverters 18 of M UPSs U is stopped and each UPS U is put into the stop state, the harmonic currents flowing out to commercial AC power supply 1 can be reduced to Ihd×(N−M), similarly to FIG. 5. However, unlike FIG. 5, inverters 18 of N−M UPSs U are required to output shared current Is, which is 1/(N−M) of load current IL. When load current IL increases abruptly and shared current Is exceeds a rated current Imax of UPS U, M UPSs U in the stop state need to be activated. As described above, UPSs U in the stop state are activated after the load increases abruptly, which leads to a concern that a response speed to load variations may become slower.

In contrast, in FIG. 5, N inverters 18 are kept in the operating state even when the operation of M converters 14 is stopped. Therefore, even when load current IL increases abruptly, the abrupt increase can be quickly addressed by increasing shared current Is. That is, uninterruptible power supply system 100 can quickly respond to the abrupt change in load current IL in which Imax×N is an upper limit.

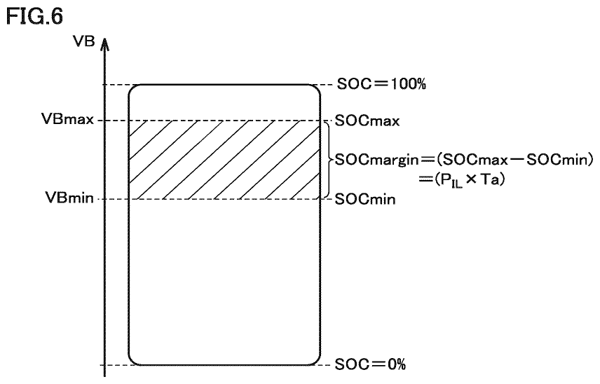

On the other hand, in M UPSs U (e.g., UPS U1) set to the battery power feeding mode, the DC power of battery B is supplied to load 2, and thus, a state of charge (SOC) of battery B decreases gradually. The SOC is a value indicating an amount of power stored in battery B, and refers to a current amount of stored power with respect to a full charge capacity of battery B expressed in percentage, for example. FIG. 6 is a diagram for describing the SOC of battery B. FIG. 6 shows the relationship between the SOC of battery B and DC voltage VB of battery terminal T2 (terminal-to-terminal voltage of battery B).

As shown in FIG. 6, for the SOC of battery B, determination values SOCmax and SOCmin are set as references for controlling charging and discharging of battery B. SOC=0% corresponds to an empty state of battery B, and SOC=100% corresponds to a fully charged state of battery B.

For the SOC, a prohibition region is set to prohibit charging of battery B in order to prevent overcharge. SOCmax is set based on the prohibition region. When SOC>SOCmax, charging of battery B is stopped. SOCmax corresponds to an example of “SOC upper limit value”. It should be noted that reference DC voltage VBR is set based on DC voltage VBmax corresponding to SOCmax. Thus, bidirectional chopper 17 is controlled such that the SOC of battery B is SOCmax in the commercial power feeding mode, and charging of battery B is performed.

SOCmin is the SOC for ensuring the function of UPS U as a backup power supply (power failure compensation function) when a power failure of commercial AC power supply I occurs. SOCmin is set to be equal to or greater than an amount of power stored for power failure compensation. “Amount of power stored for power failure compensation” refers to an amount of stored power required to continue to supply electric power from battery B to load 2 for a predetermined compensation time period when a power failure of commercial AC power supply 1 occurs. The amount of power stored for power failure compensation is calculated based on rated current Imax of UPS U and the compensation time period, assuming that load 2 when a power failure of commercial AC power supply I occurs is a rated load. In order for UPS U to ensure the power failure compensation function, it is necessary to keep the SOC of battery B equal to or greater than SOCmin when commercial AC power supply 1 is sound.

Returning to FIG. 5, a case where a power failure of commercial AC power supply 1 occurs when the SOC of battery B1 connected to UPS U1 in the battery power feeding mode decreases to be less than SOCmin is assumed. In this case, N UPSs U1 to UN are all set to the battery power feeding mode. However, as for UPS U1, the SOC is less than SOCmin, and thus, it is difficult to continue to output shared current Is for the power failure compensation time period. As a result, uninterruptible power supply system 100 as a whole cannot possibly ensure the power failure compensation function.

Thus, in the present embodiment, M UPSs U are set to the battery power feeding mode and remaining N−M UPSs U are set to the commercial power feeding mode when uninterruptible power supply system 100 is operating at light load.

Furthermore, in the above-described configuration, a rotation process for changing, in a predetermined time cycle, M UPSs U to be set to the battery power feeding mode is performed in order to suppress the SOCs of M batteries B connected to M UPSs U, respectively, from decreasing to be less than SOCmin.

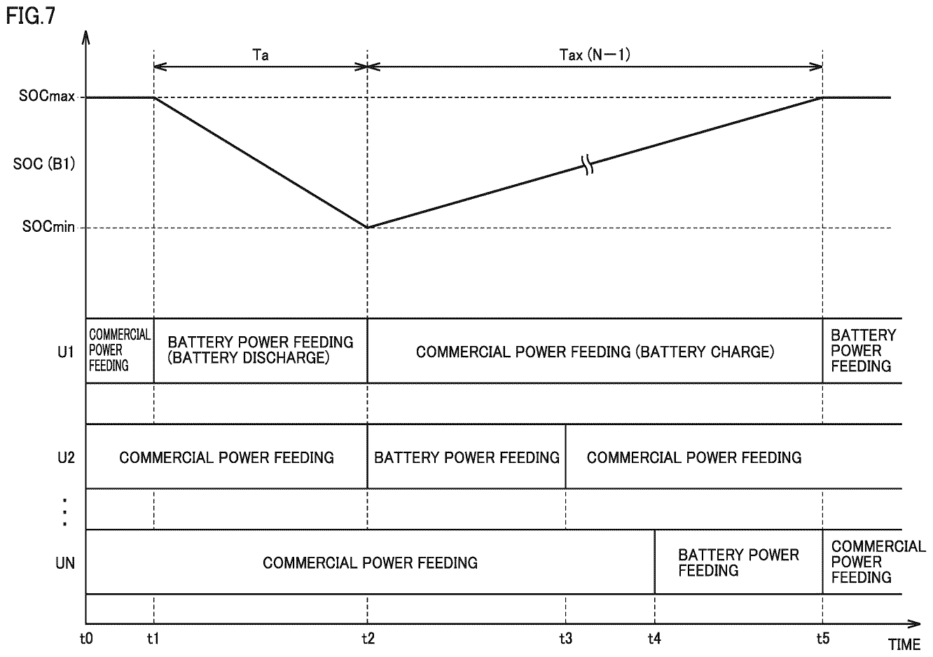

FIG. 7 is a diagram for describing the rotation process in uninterruptible power supply system 100. FIG. 7 shows transition of the power feeding mode of N UPSs U1 to UN and a temporal change in SOC of battery B1 connected to UPS U1.

As shown in FIG. 7, when load 2 is a light load, M UPSs to be set to the battery power feeding mode are changed in a predetermined time cycle Ta. In the example shown in FIG. 7, M=1.

At time t0, load 2 is not a light load, and thus, UPSs U1 to UN are all set to the commercial power feeding mode. Each of batteries B1 to BN is charged by the DC power supplied from DC line 15 of corresponding UPS U through bidirectional chopper 17, whereby the SOC is kept at SOCmax.

When load 2 becomes a light load at time t1, the rotation process is performed. In the rotation process, M UPSs U are sequentially set to the battery power feeding mode in time cycle Ta in accordance with the predetermined order.

In the example shown in FIG. 7, UPS U1 is first set to the battery power feeding mode. UPSs U2 to UN are maintained in the commercial power feeding mode. The execution of the battery power feeding mode causes the SOC of battery B1 connected to UPS U1 to gradually decrease from SOCmax after time t1.

It should be noted that time cycle Ta is set based on load current IL such that the SOC of battery B does not fall below SOCmin in the battery power feeding mode. As shown in FIG. 6, when a difference between SOCmax and SOCmin is represented by SOCmargin, UPS U1 performs the battery power feeding mode using the DC power corresponding to SOCmargin. For example, time cycle Ta is set such that the SOC does not fall below SOCmin even when inverter 18 continues to output shared current Is, which is 1/N of a threshold current Ith corresponding to the light load, for time cycle Ta.

At time t2 after a lapse of time cycle Ta since time t1, UPS U1 is switched from the battery power feeding mode to the commercial power feeding mode. Then, UPS U2 is set to the battery power feeding mode. The execution of the commercial power feeding mode causes the SOC of battery B1 connected to UPS U1 to gradually decrease after time t2.

At time t3 after a lapse of time cycle Ta since time t2, UPS U2 is switched from the battery power feeding mode to the commercial power feeding mode. Then, UPS U3 is set to the battery power feeding mode. In this way, M UPSs U are sequentially set to the battery power feeding mode in time cycle Ta. A time period from time t2 when UPS U2 is set to the battery power feeding mode to time t5 when UPS UN ends the battery power feeding mode has a length of Ta×(N−1). During this time period, UPS U1 is set to the commercial power feeding mode, whereby the SOC of battery B1 rises and recovers to SOCmax. Although not shown, the SOCs of batteries B2 to BN also recover to SOCmax for the time period having the length of Ta×(N−1) after the end of the battery power feeding mode, similarly to battery B1.

Since the operation of M converters 14 is always stopped while the rotation process is being performed, the harmonic currents flowing from uninterruptible power supply system 100 to commercial AC power supply 1 can be reduced to Ihd×(N−M). On the other hand, since N inverters 18 always continue to operate, uninterruptible power supply system 100 can quickly respond to an abrupt change in load current IL.

Furthermore, since the SOC of each battery B is kept equal to or greater than SOCmin, uninterruptible power supply system 100 can ensure the power failure compensation function even when a power failure of commercial AC power supply 1 occurs while the rotation process is being performed. As described above, in uninterruptible power supply system 100, it is possible to reduce the harmonic currents flowing out to commercial AC power supply 1, while ensuring a quick response to load variations and the power failure compensation function.

In order to smoothly perform the above-described rotation process, it is required that UPS U1 to UPS UN should not have a fault and the SOCs of batteries B1 to BN should be SOCmax at the start of the rotation process (time t1 in FIG. 7). Therefore, controller 5 monitors the occurrence of a fault in UPSs U1 to UN and the SOCs of batteries B1 to BN based on the signals exchanged between controller 5 and control circuits 25 of UPSs U1 to UN.

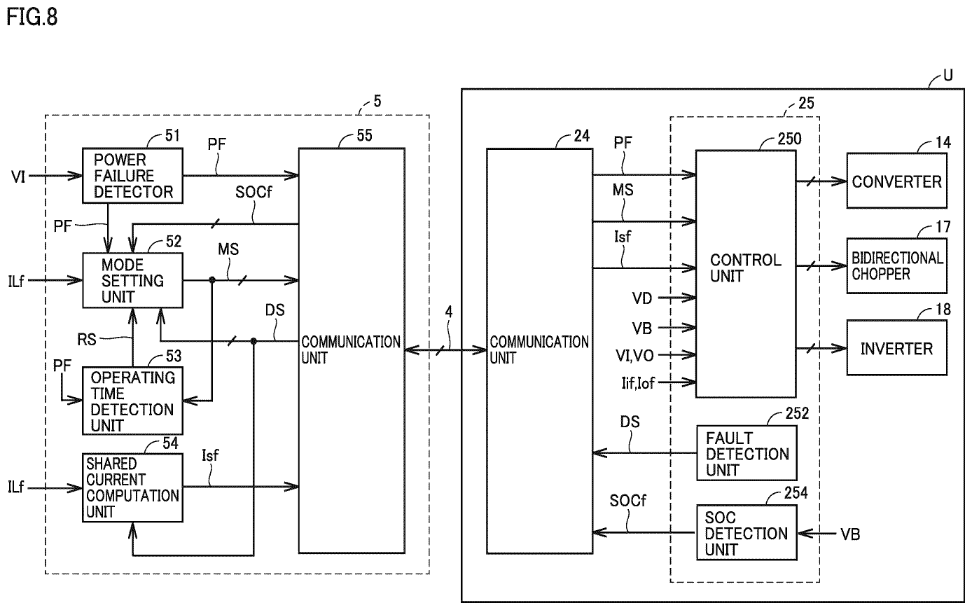

FIG. 8 is a block diagram showing configurations of controller 5 and control circuit 25 of UPS U. As shown in FIG. 8, controller 5 includes a power failure detector 51, a mode setting unit 52, an operating time detection unit 53, a shared current computation unit 54, and a communication unit 55. The function of each block shown in FIG. 8 can be implemented by at least one of software processing and hardware processing by controller 5.

Power failure detector 51 determines whether a power failure of commercial AC power supply 1 occurs, based on the detected value of AC voltage V1, and outputs a signal PF indicating a result of detection. Specifically, when AC voltage V1 is within a preset normal range, power failure detector 51 determines that commercial AC power supply 1 is sound, and outputs signal PF having the L level. When AC voltage V1 is lower than the normal range, power failure detector 51 determines that commercial AC power supply 1 has a power failure, and outputs signal PF having the H level. Output signal PF of power failure detector 51 is provided to mode setting unit 52, and is transmitted to UPSs U1 to UN through communication unit 55 and communication line 4.

Mode setting unit 52 sets each of UPSs U1 to UN to one of the commercial power feeding mode and the battery power feeding mode, based on output signal PF of power failure detector 51, signals SOCf and DS input from each UPS U through communication line 4 and communication unit 55, output signal ILf of current detector 3, and an output signal Tb of operating time detection unit 53. Signal SOCf is a signal indicating a calculated value of the SOC of each of batteries B1 to BN. Signal DS is a fault detection signal output from a fault detection unit 252 included in each UPS U. Fault detection signal DS is set to the L level when corresponding UPS U is operating normally, and is set to the H level when it is determined that this UPS U has a fault. Mode setting unit 52 outputs mode command signal MS indicating the set power feeding mode to UPSs U1 to UN through communication unit 55 and communication line 4.

When power failure detection signal PF is in the L level (when commercial AC power supply 1 has a power failure), mode setting unit 52 sets UPSs U1 to UN to the battery power feeding mode. When it is determined that any one of UPSs U1 to UN has a fault based on fault detection signal DS from each UPS U, mode setting unit 52 sets all of UPSs U other than UPS U having the fault to the battery power feeding mode.

When power failure detection signal PF is in the H level (when commercial AC power supply 1 is sound), mode setting unit 52 sets UPSs U1 to UN to one of the commercial power feeding mode and the battery power feeding mode, based on output signal ILf of current detector 3 and signals SOCf and DS from each UPS U.

Specifically, mode setting unit 52 first determines whether load 2 is a light load, based on output signal ILf of current detector 3. For example, when load current IL is smaller than predetermined threshold current Ith, mode setting unit 52 determines that load 2 is a light load. When load current IL is greater than threshold current Ith, mode setting unit 52 determines that load 2 is not a light load. For example, threshold current Ith is set to a current value of approximately 10% of rated current Imax of UPS U.

When mode setting unit 52 determines that load 2 is not a light load (IL>Ith), mode setting unit 52 sets UPSs U1 to UN to the commercial power feeding mode. When it is determined that any one of UPSs U1 to UN has a fault based on fault detection signal DS from each UPS U, mode setting unit 52 sets all of UPSs U other than UPS U having the fault to the commercial power feeding mode.

When mode setting unit 52 determines that load 2 is a light load (IL<Ith), mode setting unit 52 determines whether UPSs U1 to UN are all normal, based on fault detection signal DS from each UPS U. When fault detection signals DS from UPSs U1 to UN are all in the L level, mode setting unit 52 determines that UPSs U1 to UN are all normal. Mode setting unit 52 further determines whether the SOCs of batteries B1 to BN are equal to or greater than SOCmax, based on output signal SOCf of each UPS U.

When all of UPSs U1 to UN are not normal or when the SOC of at least one of batteries B1 to BN is less than SOCmax, mode setting unit 52 sets UPSs U1 to UN to the commercial power feeding mode.

When UPSs U1 to UN are all normal and when the SOCs of batteries B1 to BN are equal to or greater than SOCmax, mode setting unit 52 sets M UPSs U of UPSs U1 to UN to the battery power feeding mode and sets N−M UPSs U to the commercial power feeding mode. At this time, mode setting unit 52 performs the rotation process on M UPSs U to be set to the battery power feeding mode, based on an output signal RS of operating time detection unit 53.

Specifically, when output signal PF of power failure detector 51 is in the L level (when commercial AC power supply 1 is sound), operating time detection unit 53 detects an operating time of M UPSs U set to the battery power feeding mode. In response to the arrival of the detected operating time at time cycle Ta, operating time detection unit 53 raises signal RS from the L level to the H level.

In response to the rising of output signal RS of operating time detection unit 53 to the H level, mode setting unit 52 changes M UPSs U in accordance with the predetermined order. Operating time detection unit 53 is reset in response to the change of M UPSs U, and detects an operating time of changed M UPSs U.

Shared current computation unit 54 divides load current IL represented by output signal ILf of current detector 3 by the number of normal UPSs U, to calculate shared current Is of each UPS U. When UPSs U1 to UN are all normal, shared current Is is a current that is 1/N of load current IL. Shared current computation unit 54 outputs a signal Isf indicating shared current Is to UPSs U1 to UN through communication unit 55 and communication line 4.

Control circuit 25 of UPS U includes a control unit 250, fault detection unit 252 and an SOC detection unit 254. The function of each block shown in FIG. 8 can be implemented by at least one of software processing and hardware processing by control circuit 25.

Control unit 250 controls converter 14, bidirectional chopper 17 and inverter 18 based on signals PF, MS and Isf transmitted from controller 5 through communication line 4, the detected values of AC voltages VI and VO, the detected values of DC voltages VD and VB, output signals Iif and Iof of current detectors 22 and 23, and the like. Control unit 250 includes control portions of bidirectional chopper 17 and inverter 18, in addition to a control portion of converter 14 shown in FIG. 3.

That is, in the commercial power feeding mode, control unit 250 controls bidirectional chopper 17 such that terminal-to-terminal voltage VB of battery B is reference DC voltage VBR. In the battery power feeding mode, control unit 250 controls bidirectional chopper 17 such that DC voltage VD of DC line 15 is reference DC voltage VDR. In addition, in the commercial power feeding mode and in the battery power feeding mode, control unit 250 controls inverter 18 such that the output current of inverter 18 is shared current Is.

Fault detection unit 252 determines whether corresponding UPS U has a fault, and generates fault detection signal DS based on a result of determination. As described above, fault detection signal DS is set to the L level when corresponding UPS U is operating normally, and fault detection signal DS is set to the H level when it is determined that this UPS U has a fault. Fault detection unit 252 transmits fault detection signal DS to controller 5 through communication unit 24 and communication line 4.

SOC detection unit 254 detects the SOC of battery B based on the detected value of DC voltage VB of battery terminal T2 (terminal-to-terminal voltage of battery B). A known method such as a method using a OCV-SOC curve indicating a relationship between an open circuit voltage (OCV) and the SOC of battery B can be used as a method for detecting the SOC. SOC detection unit 254 transmits signal SOCf indicating the detected value of the SOC to controller 5 through communication unit 24 and communication line 4.

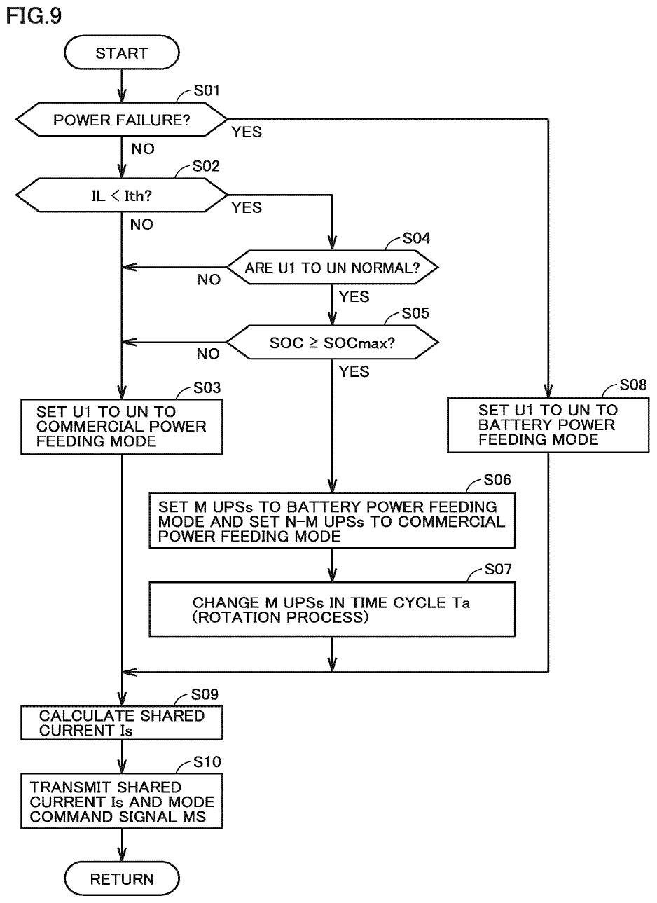

FIG. 9 is a flowchart for describing the control of each UPS U by controller 5. The flowchart in FIG. 9 is repeatedly performed by controller 5 during operation of uninterruptible power supply system 100.

As shown in FIG. 9, in step (hereinafter, simply denoted as “S”) 01, controller 5 determines whether commercial AC power supply 1 has a power failure, based on the detected value of AC voltage V1. Controller 5 makes a determination of NO in S01 when AC voltage V1 is within the normal range, and makes a determination of YES in S01 when AC voltage V1 is lower than the normal range.

When commercial AC power supply 1 has a power failure (YES in S01), controller 5 moves the process to S08 and sets UPSs U1 to UN to the battery power feeding mode.

When commercial AC power supply 1 is sound (NO in S01), then, in S02, controller 5 determines whether load 2 is a light load, based on output signal ILf of current detector 3. In S02, load current IL and threshold current Ith are compared. When IL<Ith, controller 5 determines that load 2 is a light load (YES in S02). When IL≥Ith, controller 5 determines that load 2 is not a light load (NO in S02).

When load 2 is not a light load (NO in S02), controller 5 moves the process to S03 and sets UPSs U1 to UN to the commercial power feeding mode.

When load 2 is a light load (YES in S02), then, in S04, controller 5 determines whether UPSs U1 to UN are normal, based on fault detection signal DS from each UPS U. Furthermore, in S05, controller 5 determines whether the SOCs of batteries B1 to BN are equal to or greater than SOCmax, based on signal SOCf from each UPS U.

When any one of UPSs U1 to UN has a fault (NO in S04) or when the SOC of any one of batteries B1 to BN is less than SOCmax (NO in S05), controller 5 sets UPSs U1 to UN to the commercial power feeding mode in S03.

When UPSs U1 to UN are all normal (YES in S04) and when the SOCs of batteries B1 to BN are all equal to or greater than SOCmax (YES in S05), then, in S06, controller 5 sets M UPSs U of UPSs U1 to UN to the battery power feeding mode and sets N−M UPSs U to the commercial power feeding mode.

Furthermore, in S07, controller 5 performs the rotation process for changing M UPSs U in time cycle Ta (see FIG. 7).

When the power feeding mode of each of UPSs U1 to UN is set, then, in S09, controller 5 divides load current IL represented by output signal ILf of current detector 3 by the number of normal UPSs U, to calculate shared current Is of each UPS U.

In S10, controller 5 transmits the signal indicating shared current Is and mode command signal MS to each UPS U through communication line 4.

As described above, in the uninterruptible power supply system according to the first embodiment, when the commercial AC power supply is sound and when the load is a light load, the M UPSs, of the N UPSs connected in parallel between the commercial AC power supply and the load, are set to the battery power feeding mode and the N−M UPSs are set to the commercial power feeding mode, whereby it is possible to reduce the harmonic currents flowing out to the commercial AC power supply, while ensuring a quick response to load variations and the power failure compensation function.

### Second Embodiment

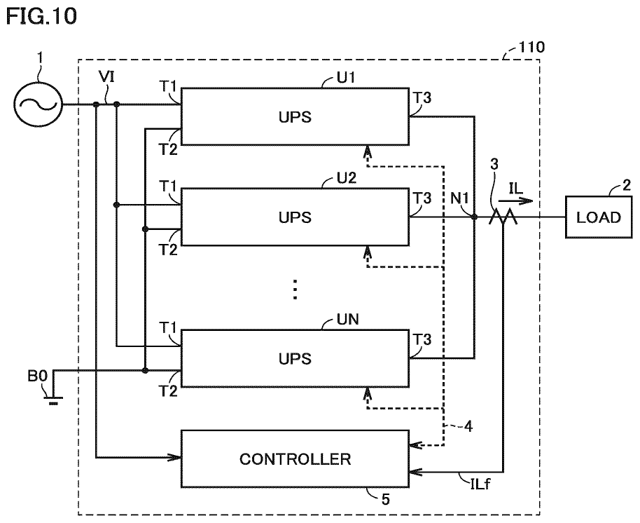

FIG. 10 is a circuit block diagram showing a configuration of an uninterruptible power supply system according to a second embodiment. An uninterruptible power supply system 110 according to the second embodiment receives three-phase AC power of a commercial frequency from commercial AC power supply 1 and supplies the three-phase AC power of the commercial frequency to load 2. However, for the sake of simplification of the figure and the description, FIG. 10 shows only a portion related to one phase.

Uninterruptible power supply system 110 according to the second embodiment is different from uninterruptible power supply system 100 shown in FIG. 1 in that a single battery B0 is connected, instead of batteries B1 to BN.

In the second embodiment, battery terminals T2 of UPSs U1 to UN are connected to common battery B0. Battery B0 constitutes “storage battery” that stores DC power. Battery B0 is a secondary battery such as a lead-acid battery or a lithium battery. Instead of battery B0, an electric double-layer capacitor may be connected. Since the configurations of UPSs U1 to UN are the same as the configuration of UPS U shown in FIG. 2, description will not be repeated.

In uninterruptible power supply system 110 as well, by performing the flowchart shown in FIG. 9, controller 5 can set M UPSs U of UPSs U1 to UN to the battery power feeding mode and set N−M UPSs U to the commercial power feeding mode when commercial AC power supply 1 is sound and when load 2 is a light load.

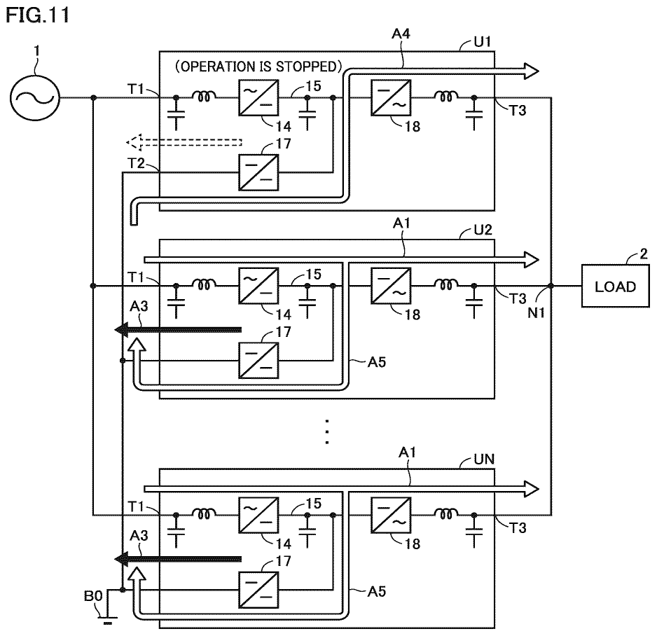

FIG. 11 shows an operation of uninterruptible power supply system 110 when M=1. In FIG. 11, UPS U1 is set to the battery power feeding mode and UPSs U2 to UN are set to the commercial power feeding mode.

In FIG. 11, arrow A4 indicates a path through which electric power is supplied in UPS U1. In UPS U1, the operation of converter 14 is stopped and the DC power of battery B0 is supplied to DC line 15 through bidirectional chopper 17. The DC power supplied from bidirectional chopper 17 to DC line 15 is converted into AC power by inverter 18 and the AC power is supplied to load 2. Inverter 18 outputs shared current Is. In UPS U1, the operation of converter 14 is stopped, and thus, no harmonic current is generated. That is, Ihd=0.

Each of arrows A1 and A5 indicate a path through which electric power is supplied in UPSs U2 to UN. In UPSs U2 to UN, the AC power supplied from commercial AC power supply 1 is converted into DC power by converter 14 and the DC power is supplied to DC line 15, as shown by arrow A1. The DC power supplied to DC line 15 is converted into AC power by inverter 18 and the AC power is supplied to load 2. Inverter 18 outputs shared current Is, which is I/N of load current IL. The DC power supplied to DC line 15 is further stored in battery B0 through bidirectional chopper 17, as shown by arrow A5.

In the second embodiment as well, the harmonic currents flowing from uninterruptible power supply system 110 to commercial AC power supply I can be reduced from Ihd×N to Ihd×(N−M), similarly to the first embodiment. In addition, when viewed from the load 2 side, each of N inverters 18 outputs shared current Is, and thus, load 2 can be supplied with load current IL. Therefore, load 2 is not affected by the stop of the operation of M converters 14. That is, the second embodiment can also provide the same effect as that of the first embodiment.

In the second embodiment, a DC current required for inverters 18 of M UPSs U to output shared current Is is supplied from battery B0 to M UPSs U, unlike the first embodiment. On the other hand, a DC current required to keep terminal-to-terminal voltage VB of battery B0 at reference DC voltage VBR is supplied from N−M UPSs U to battery B0.

Here, the magnitude of the DC current supplied from battery B0 to each of M UPSs U is represented by IbL, and the magnitude of the DC current supplied from each of N−M UPSs U to battery B0 is represented by Ic. A DC current supplied from battery B0 to M UPSs U (corresponding to a discharge current of battery B0) is expressed as IbL×M. A DC current supplied from N−M UPSs U to battery B0 (corresponding to a charge current of battery B0) is expressed as Ic×(N−M).

By setting a value of M such that the relationship of IbL×M≤Ic×(N−M) is satisfied between IbL×M and Ic×(N−M), takeout of the DC power from battery B0 when M UPSs U are set to the battery power feeding mode can be reduced to substantially zero. In the example shown in FIG. 11, at least a part of the DC power supplied from UPSs U2 to UN is supplied to UPS U1, whereby takeout of the DC power from battery B0 is reduced to zero. According to this, even when M UPSs U are set to the battery power feeding mode, the SOC of battery B0 is kept equal to or greater than SOCmin, and thus, the power failure compensation function of uninterruptible power supply system 100 can be ensured.

In the second embodiment, UPSs U1 to UN are connected to common battery B0. Therefore, the rotation process for changing, in time cycle Ta, M UPSs U to be set to the battery power feeding mode (see FIG. 7) does not necessarily need to be performed.

In addition, as long as the relationship of IbL×M≤Ic×(N−M) is satisfied between IbL×M and Ic×(N−M), the number M of UPSs U to be set to the battery power feeding mode can be increased in accordance with the magnitude of shared current Is. Specifically, as shared current Is becomes smaller, DC current IbL supplied from battery B0 to M UPSs U becomes smaller. On the other hand, DC current Ic supplied from N−M UPSs U to battery B0 can be increased. Therefore, even when the value of M is increased, the above-described relationship can be satisfied and takeout of the DC power from battery B0 can be reduced to zero.

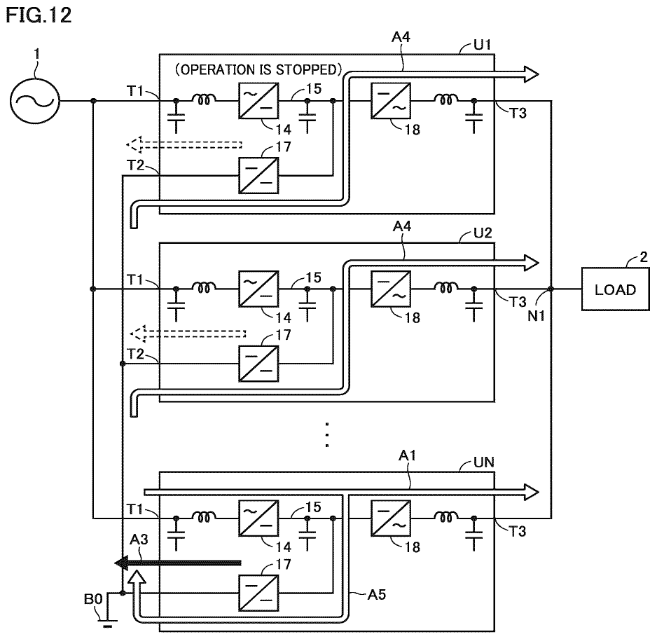

When M=2 as shown in FIG. 12, for example, the number of converters 14 whose operation is stopped increases, as compared with when M=1 as shown in FIG. 11. Therefore, the harmonic currents flowing out to commercial AC power supply 1 can be further reduced.

It should be understood that the embodiments disclosed herein are illustrative and non-restrictive in every respect. The scope of the present disclosure is defined by the terms of the claims, rather than the description above, and is intended to include any modifications within the scope and meaning equivalent to the terms of the claims.

### REFERENCE SIGNS LIST

1 commercial AC power supply; 2 load; 3, 22, 23 current detector; 4 communication line; 5 controller; 11, 16, 20 capacitor; 12, 19 reactor; 13, 21 AC filter; 14 converter; 15 DC line; 17 bidirectional chopper; 18 inverter; 24, 55 communication unit; 25 control circuit; 51 power failure detector; 52 mode setting unit; 53 operating time detection unit; 54 shared current computation unit; 100, 110 uninterruptible power supply system; 240 reference voltage generation circuit; 242 voltage control circuit; 244 current control circuit; 246 PWM circuit; 250 control unit; 252 fault detection unit; 254 SOC detection unit; U1 to UN, U uninterruptible power supply device; B0 to BN, B battery; T1 input terminal; T2 battery terminal; T3 output terminal; S1 to S3 switch.

1. An uninterruptible power supply system comprising:
N uninterruptible power supply devices connected in parallel between an AC power supply and a load;
a current detector that detects a load current; and
a controller, N being an integer equal to or greater than 2, M being an integer equal to or greater than 1 and less than N, wherein
each of the uninterruptible power supply devices includes:
a DC line that transmits DC power;
a converter that converts AC power supplied from the AC power supply into DC power and supplies the DC power to the DC line; and
an inverter that converts DC power received from the DC line into AC power and supplies the AC power to the load,
each of the uninterruptible power supply devices is configured to switch between a first power feeding mode and a second power feeding mode, the first power feeding mode being a mode of supplying the DC power generated by the converter to the inverter and storing the DC power in a power storage device, the second power feeding mode being a mode of supplying the DC power of the power storage device to the inverter, and
the controller
i) sets the N uninterruptible power supply devices to the first power feeding mode, when the AC power supply is sound and when the load current detected by the current detector is greater than a predetermined threshold current,
ii) sets the N uninterruptible power supply devices to the second power feeding mode, when the AC power supply has a power failure, and
iii) sets the M uninterruptible power supply devices of the N uninterruptible power supply devices to the second power feeding mode and sets the N−M uninterruptible power supply devices to the first power feeding mode, when the AC power supply is sound and when the load current detected by the current detector is smaller than the threshold current.

2. The uninterruptible power supply system according to claim 1, wherein
each of the uninterruptible power supply devices further includes a bidirectional chopper that receives and transmits DC power between the DC line and the power storage device,
in the first power feeding mode,
the converter converts the AC power supplied from the AC power supply into DC power and supplies the DC power to the DC line, and
the bidirectional chopper supplies the DC power from the DC line to the power storage device, and
in the second power feeding mode,
operation of the converter is stopped, and
the bidirectional chopper supplies the DC power of the power storage device to the DC line.

3. The uninterruptible power supply system according to claim 1, wherein
in the first and second power feeding modes, the inverter supplies a shared current to the load, the shared current being 1/N of the load current.

4. The uninterruptible power supply system according to claim 1, wherein
the power storage device is N storage batteries connected to the N uninterruptible power supply devices, respectively, and
when the AC power supply is sound and when the load current detected by the current detector is smaller than the threshold current, the controller performs a rotation process for changing, in a predetermined time cycle, the M uninterruptible power supply devices to be set to the second power feeding mode.

5. The uninterruptible power supply system according to claim 4, wherein
when the N uninterruptible power supply devices are normal and when SOCs of the N storage batteries are equal to or greater than an SOC upper limit value, the controller performs the rotation process.

6. The uninterruptible power supply system according to claim 4, wherein
an amount of power stored for power failure compensation is set for the storage batteries, the amount of power stored for power failure compensation being an amount of stored power required to supply AC power from the storage batteries to the load until a predetermined compensation time period elapses since a power failure of the AC power supply occurs, and
the time cycle is set based on the load current, such that SOCs of the M storage batteries connected to the M uninterruptible power supply devices, respectively, do not fall below the amount of power stored for power failure compensation.

7. The uninterruptible power supply system according to claim 1, wherein
the power storage device is one storage battery commonly connected to the N uninterruptible power supply devices, and
when the AC power supply is sound and when the load current detected by the current detector is smaller than the threshold current, a value of M is set such that a total of DC currents supplied from the storage battery to the DC lines of the M uninterruptible power supply devices does not exceed a total of DC currents supplied from the DC lines of the N-M uninterruptible power supply devices to the storage battery.

8. The uninterruptible power supply system according to claim 1, wherein
the converter includes a plurality of semiconductor switching elements, and
each of the N uninterruptible power supply devices includes:
a control circuit that turns on and off the plurality of semiconductor switching elements in accordance with pulse width modulation (PWM) control; and
a communication line that communicatively connects the control circuit and the controller.

9. The uninterruptible power supply system according to claim 2, wherein
the power storage device is N storage batteries connected to the N uninterruptible power supply devices, respectively, and
when the AC power supply is sound and when the load current detected by the current detector is smaller than the threshold current, the controller performs a rotation process for changing, in a predetermined time cycle, the M uninterruptible power supply devices to be set to the second power feeding mode.

10. The uninterruptible power supply system according to claim 3, wherein
the power storage device is N storage batteries connected to the N uninterruptible power supply devices, respectively, and
when the AC power supply is sound and when the load current detected by the current detector is smaller than the threshold current, the controller performs a rotation process for changing, in a predetermined time cycle, the M uninterruptible power supply devices to be set to the second power feeding mode.

11. The uninterruptible power supply system according to claim 2, wherein
the power storage device is one storage battery commonly connected to the N uninterruptible power supply devices, and
when the AC power supply is sound and when the load current detected by the current detector is smaller than the threshold current, a value of M is set such that a total of DC currents supplied from the storage battery to the DC lines of the M uninterruptible power supply devices does not exceed a total of DC currents supplied from the DC lines of the N-M uninterruptible power supply devices to the storage battery.

12. The uninterruptible power supply system according to claim 3, wherein
the power storage device is one storage battery commonly connected to the N uninterruptible power supply devices, and
when the AC power supply is sound and when the load current detected by the current detector is smaller than the threshold current, a value of M is set such that a total of DC currents supplied from the storage battery to the DC lines of the M uninterruptible power supply devices does not exceed a total of DC currents supplied from the DC lines of the N-M uninterruptible power supply devices to the storage battery.

13. The uninterruptible power supply system according to claim 2, wherein
the converter includes a plurality of semiconductor switching elements, and
each of the N uninterruptible power supply devices includes:
a control circuit that turns on and off the plurality of semiconductor switching elements in accordance with pulse width modulation (PWM) control; and
a communication line that communicatively connects the control circuit and the controller.

14. The uninterruptible power supply system according to claim 3, wherein
the converter includes a plurality of semiconductor switching elements, and
each of the N uninterruptible power supply devices includes:
a control circuit that turns on and off the plurality of semiconductor switching elements in accordance with pulse width modulation (PWM) control; and
a communication line that communicatively connects the control circuit and the controller.
